(19) United States
(12) Patent Application Publication
(10) Pub. No.: US 2024/0053300 A1
(43) Pub. Date: Feb. 15, 2024

(54) ULTRASONIC STRUCTURAL HEALTH MONITORING DEVICE, SYSTEM AND METHOD

(71) Applicant: NATIONAL RESEARCH COUNCIL OF CANADA, Ottawa (CA)

(72) Inventors: Silvio Elton KRUGER, Brossard (CA); David ROCHELEAU, Longueuil (CA); Zhigang SUN, Greenfield Park (CA); Kuo-Ting WU, Brossard (CA)

(73) Assignee: NATIONAL RESEARCH COUNCIL OF CANADA, Ottawa, ON (CA)

(21) Appl. No.: 18/023,356

(22) PCT Filed: Aug. 20, 2021
(86) PCT No.: PCT/CA2021/051162

§ 371 Date: Feb. 25, 2023

Related U.S. Application Data
(60) Provisional application No. 63/092,621, filed on Oct. 16, 2020.
(60) Provisional application No. 63/074,112, filed on Sep. 3, 2020.

(51) Int. Cl. G01N 29/07; G01N 29/24

(52) U.S. Cl. CPC G01N 29/07; G01N 29/2437; G01N 2291/044; G01N 2291/0289

(57) ABSTRACT

Described are various embodiments of an ultrasonic structural health monitoring device, system and method. In one embodiment, an ultrasonic structural health monitoring device is described to monitor a structure. The device comprises a bottom electrode disposable on the structure; a piezoelectric medium disposed on the bottom electrode; a top electrode disposed on the piezoelectric medium; an acoustic insulation layer; and a connector to bring electrical excitation for the piezoelectric medium and to collect a generated electric response therefrom representative of structural health.

### FIELD OF THE DISCLOSURE

The present disclosure relates to ultrasonic structural health monitoring, and, in particular, to an ultrasonic structural health monitoring device, system and method.

### BACKGROUND

Many industrial assets or critical structures are subject to deterioration by corrosion, erosion, fatigue, cracking, creep, etc. that can compromise their basic function and/or cause failure.

Ultrasonic monitoring of these industrial assets can be an efficient way to prevent catastrophic failure while optimizing maintenance and production. Most available ultrasonic transducers are too bulky and expensive to be used in large scale for monitoring applications. Some low-profile ultrasonic transducers have been developed but most are not completely sealed or electrically shielded to operate in harsh environments. Also, some applications need a very small footprint and/or low-weight transducers to be able to embed them into their structures. There is therefore a need for improvement.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for an ultrasonic structural health monitoring device, system and method that overcome some of the drawbacks of known solutions, or at least, provide a useful alternative thereto. Some aspects of this disclosure provide examples of such devices, systems and methods, in accordance with different embodiments.

In accordance with one aspect, there is provided an ultrasonic structural health monitoring device for monitoring a structure, the device comprising: a bottom electrode disposable on the structure; a piezoelectric medium disposed on said bottom electrode; a top electrode disposed on said piezoelectric medium; an acoustic insulation layer; and a connector to bring electrical excitation for said piezoelectric medium and to collect a generated electric response therefrom representative of structural health.

In one embodiment, the piezoelectric medium transforms said electrical excitation into a corresponding ultrasonic wave that is reflected as an echo by the structure to produce said generated electric response representative of said structural health.

In one embodiment, the thickness of the structure is represented by an elapsed time between said electrical excitation and said generated electric response, such that a variation in said elapsed time is representative of said structural health.

In one embodiment, the piezoelectric medium comprises a piezoelectric layer deposited on said bottom electrode.

In one embodiment, the piezoelectric layer comprises a piezoelectric film.

In one embodiment, the device further comprises a cover layer.

In one embodiment, the device further comprises an electrically non-conductive high-temperature resistant coating layer disposed on said cover layer.

In one embodiment, the electrically non-conductive high-temperature resistant

coating layer is made from a polyimide adhesive tape.

In one embodiment, the piezoelectric medium is made from a mix of a piezoelectric ceramic powder with a binding material and sprayed on said bottom electrode.

In one embodiment, the bottom electrode is a metallic substrate.

In one embodiment, the metallic substrate comprises aluminum.

In one embodiment, the connector comprises a cable.

In one embodiment, the cable is coaxially positioned with said piezoelectric

medium.

In one embodiment, the cable comprises a shield layer connected to said bottom electrode and a core connected to said top electrode.

In one embodiment, the connector comprises an induction coil.

In one embodiment, the device further comprises a sealant that fills at least part of the device.

In one embodiment, the sealant is an adhesive sealant.

In one embodiment, the adhesive sealant comprises an ultralow water vapor transfer rate adhesive.

In one embodiment, the device further comprises a protective rim so as to prevent sealant material from coming in contact with said piezoelectric medium.

In one embodiment, the protective rim is made from a single-sided polyimide adhesive tape.

In one embodiment, the device further comprises a magnet to removably attach

the device to the structure to be monitored.

In one embodiment, the magnet is located over said acoustic insulating layer.

In one embodiment, the magnet is annular and configured so as to surround said piezoelectric medium.

In one embodiment, the device further comprises a substantially disk-shaped rubber element located above said acoustic insulating layer and configured to apply a downward compression force.

In one embodiment, the device further comprises a plastic film layer.

In one embodiment, the plastic film layer partially covers a back face of said bottom electrode except for an area thereof in line with said piezoelectric medium.

In one embodiment, the device further comprises an edge cushion substantially covering at least one edge of said bottom electrode so as to protect said connector.

In one embodiment, the edge cushion is made from a single-sided hot-melt laminating film.

In one embodiment, the device comprises two or more sensing elements, and wherein said connector is connected to each of said two or more sensing elements in series so to commonly bring said electrical excitation to each of said two or more sensing elements.

In one embodiment, the device comprises two or more sensing elements, each one of which operatively connected via a respective said connector.

In one embodiment, the one said respective connector is operated to bring said electrical excitation whereas another said respective connector is operated to collect said generated electric response.

In one embodiment, the device comprises two or more sensing elements sharing at least one of said bottom electrode, said piezoelectric medium, said top electrode, or said acoustic insulation layer.

In one embodiment, the device is mountable to an external surface of the structure.

In one embodiment, the structure comprises a liner, and wherein the device is embeddable between the structure and the liner so as to monitor liner thickness variation.

In one embodiment, the connector is operatively connected to a pulser/receiver operable to generate said electrical excitation and receive said generated electric response.

In one embodiment, the acoustic insulation layer is disposed over said top electrode.

In one embodiment, the generated electric response representative of structural health is representative of at least one of structural wear, corrosion, pitting, icing or cracking.

In one embodiment, the cover layer comprises a metallic layer.

In accordance with another aspect, there is provided an ultrasonic structural health monitoring system for monitoring a structure, the system comprising: an ultrasonic structural health monitoring device as defined above; a pulser/receiver operable to generate said electrical excitation and receive said generated electric response; and a digital processor operable to output indication of said structural health as a function of an elapsed time between said electrical excitation and said generated electrical response.

In one embodiment, the ultrasonic structural health monitoring device comprises multiple sensing elements connected in series via a common said connector to be concurrently excited via a same electrical excitation; and the digital processor is operable to output indication of a maximum wear as a function of a shortest elapsed time between said same electrical excitation and a first said generated electrical response.

In accordance with another aspect, there is provided an ultrasonic structural health monitoring method for monitoring a structure, the method comprising: affixing to the structure an ultrasonic structural health monitoring device as defined above; exciting said ultrasonic structural health monitoring device via said electrical excitation and collecting said generated electrical response therefrom; and using a digital processor, monitoring an elapsed time between said electrical excitation and said generated electrical response to output an indication of said structural health as a function of said elapsed time.

In one embodiment, the ultrasonic structural health monitoring device comprises multiple sensing elements connected in series via a common said connector to be concurrently excited via a same said electrical excitation; and the digital processor is operable to monitor for a shortest said elapsed time to output indication of a maximum wear as a function of said shortest said elapsed time.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIGS. 1A and 1B are schematic diagrams illustrating how an ultrasonic transducer may be used for structural health (e.g. wear or thickness) monitoring;

FIGS. 2A and 2B are a cross-sectional view and an exploded view, respectively, of a structural health monitoring device comprising a single-element ultrasonic transducer, in accordance with one embodiment;

FIGS. 3A and 3B are exploded views of a single-element ultrasonic transducer where a magnet is added to provide an attaching force to the part to be monitored, in accordance with two different embodiments;

FIGS. 4A to 4D are schematic side-views of different embodiments of a linearly extended ultrasonic transducer, in accordance with different embodiments;

FIG. 5 is an exploded view of a structural health monitoring device comprising a multi-element ultrasonic transducer where each sensing element is individually connected to its own corresponding coaxial cable connection, in accordance with one embodiment;

FIG. 6 is an exploded view of a multi-element ultrasonic transducer with rectangular geometry, in accordance with one embodiment;

FIG. 7 is an exploded view of a structural health monitoring device comprising a multi-element ultrasonic transducer where various sensing elements are connected to a same coaxial cable, in accordance with one embodiment;

FIGS. 8A and 8B are schematic diagrams illustrating how a multi-element ultrasonic transducer using a single coaxial cable may be used to detect the highest level of wear or smallest thickness of the structure or object being monitored, in accordance with one embodiment;

FIG. 9 is a schematic diagram illustrating how multiple linearly-extended ultrasonic transducers may be interconnected so as to cover a substantially two-dimensional area, in accordance with one embodiment;

FIGS. 10A and 10B are a schematic side and top views, respectively, of a single-element ultrasonic transducer to be embedded between a liner and an intermediate layer or between a liner and a structural support layer to monitor liner degradation, in accordance with one embodiment;

FIG. 11 is a schematic side view of a variation of the single-element ultrasonic transducer of FIGS. 10A and 10B, in accordance with one embodiment;

FIG. 12 is a schematic side view of yet another variation of the single-element ultrasonic transducer of FIGS. 10A and 10B, in accordance with one embodiment;

FIGS. 13A and 13B are a schematic side view and bottom view, respectively, of another variation of the single-element ultrasonic transducer of FIGS. 10A and 10B, in accordance with one embodiment;

FIGS. 14A and 14B are schematic side views of a high-temperature resistant and a high-corrosion resistant variation, respectively, of the single-element ultrasonic transducer of FIGS. 10A and 10B, in accordance with one embodiment;

FIGS. 15A to 15C are a top view, side view and bottom view of a variation of the single-element ultrasonic transducer of FIGS. 10A and 10B, wherein an induction coil is used instead of a coaxial cable, in accordance with one embodiment; and

FIGS. 16A and 16B are schematic top views of a dual-element ultrasonic transducer using two coaxial cables or two induction coils, respectively, in accordance with respective embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

Current technologies rely on ultrasonic transducer designs that have limited market applications, due to the issues noted above. Thus, widespread use of ultrasonic transducers for structural health monitoring or predictive maintenance applications may require, in some embodiments, low cost, low footprint and harsh environment capable transducers.

The present disclosure provides examples, in accordance with different embodiments, of a structural health (for example, wear or thickness) monitoring device consisting of a thin, sealed and shielded flexible ultrasonic transducer that is potentially very low cost. These ultrasonic transducers may be used in a single-element or a multi-element configuration, and may be easily glued or otherwise attached to an object or structure (i.e. liner, wall, beam, etc.), or a portion thereof, to be monitored, including areas of limited space, difficult access during operation and/or harsh environment. Also, these new ultrasonic transducer designs can be of significant interest for aerospace applications where the weight of the transducer is a critical consideration. In addition, the below discussed embodiments may further be used to detect the presence of ice on a structure or object.

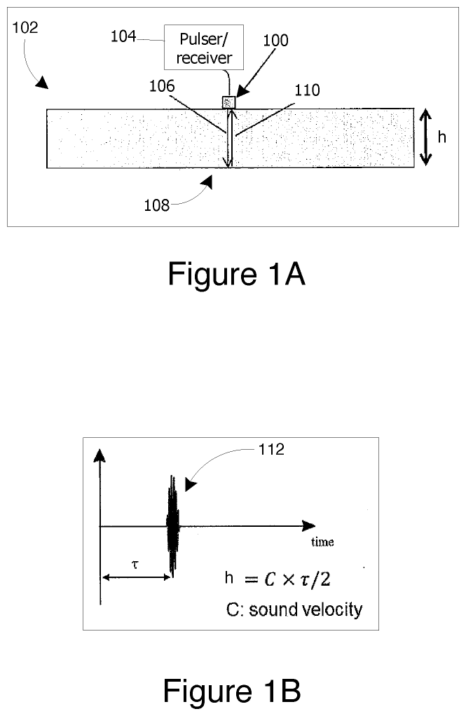

FIGS. 1A and 1B illustrate schematically how ultrasonic transducers may be used for structural health monitoring, and in particular, wear or thickness monitoring applications. This generally involves attaching an ultrasonic (ultrasound) transducer 100 to a surface of an object or structure 102 to be monitored, said ultrasonic transducer 100 comprising therein a piezoelectric medium (e.g. component, layer or film) operable to transform an input electrical signal originating from a pulser/receiver device 104 into a diagnostic ultrasonic wave 106 which propagates through structure 102. In particular, the diagnostic ultrasonic wave 106 can propagate through a thickness h of the structure 102. It can, for example, be reflected at an opposing wear face or surface 108, generating an echo 110 reflected off wear face 108. As illustrated in FIG. 1B, the echo 110 generates via the piezoelectric component 100 an electrical echo signal 112 which is sent back to said pulser/receiver device 104 (or to an acquisition device or digital computer connected thereto). The time of flight ti, defined as the elapsed time between the emission of the input electrical signal and the return of echo signal 112 may be used to compute, using a known value of the speed of sound C inside structure 102, the thickness of the material (here thickness h for example) located under ultrasonic transducer 100. Thus, in an exemplary application, a change in thickness is indicative of a wear or degradation of wear face or surface 106 that may be actively monitored via transducer 100. Other structural health applications may target corrosion, pit detection, icing detection or fatigue crack detection in similar ways. For example, the systems and devices as described herein may be operated to monitor for the appearance and growth of discontinuities like cracks. Indeed, in such embodiments, the amplitude and time of arrival of the extra acoustic echoes generated by these discontinuities as well as the combination of echo characteristics from multiple elements may allow the dimensioning and positioning of the discontinuities inside the structure. Accordingly, while most examples are provided below within the context of structural wear applications, other structural health applications may also be considered.

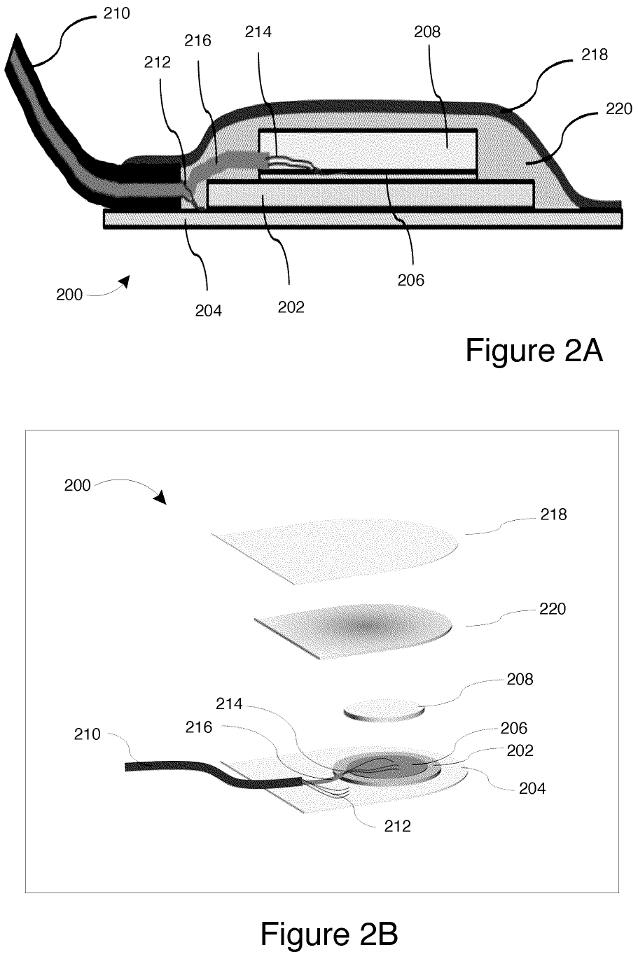

With reference to FIGS. 2A and 2B, and in accordance with one exemplary embodiment, a structural health monitoring device (sometimes referred to as a wear monitoring device) comprising a single-element ultrasonic transducer, generally referred to using the numeral 200, will now be described. FIGS. 2A and 2B show a cross-sectional view and an exploded view, respectively, of an exemplary single-element ultrasonic transducer 200, in accordance with one embodiment.

As illustrated in FIGS. 2A and 2B, single-element ultrasonic transducer 200 generally comprises a single sensing element, which includes a piezoelectric film 202 overlaid on top of a conductive substrate 204 (in use, meant to be in physical contact with a surface of structure 102) and that functions as a bottom electrode. Piezoelectric film 202 may be made from a substantially piezoelectric material, such as a piezoelectric ceramic material for example. In particular, piezoelectric film 202 may be made from a mix of a piezoelectric ceramic powder with a binding material, sprayed on conductive substrate 204 (functioning as bottom electrode). On the top of piezoelectric film 202 lays a conductive layer 206 made of a substantially electrically conductive material so as to function as a top electrode. Overlaid above conductive layer 206, is an acoustic insulation layer 208 made of a substantially acoustically insulating or absorbing material, to ensure that no acoustic energy will leak in the case when single-element ultrasonic transducer 200 is embedded. Transducer 200 further uses a coaxial cable 210 to bring the electrical excitation originating from a pulser/receiver unit (not shown) to piezoelectric film 202 and similarly collect and send back the generated electrical return echo signal. Coaxial cable 210 is shown comprising a shield layer or wire 212, a core wire 214 and a dielectric portion 216, where the shield layer 212 is connected to bottom substrate 204 (the bottom electrode), while core wire 214 is connected to the conductive layer 206 (the top electrode), thereby forming the electrical circuit.

In some embodiments, acoustic insulation layer 208 may be made, at least in part, of a material that is also substantially electrically conductive so as to make the electrical connection of the core wire 214 to the top electrode (conductive layer 206) more robust. In such an embodiment, it may be desirable to have a top portion of acoustic insulation layer 208 (or another distinct layer overlaid thereon, not shown) comprising a substantially electrically insulating or dielectric material, so as to avoid electrical contacts between acoustic insulation layer 208 and a conductive cover layer 218. Similarly, a space between cover layer 218 and any other components may further be filled with a sealant material 220, which may also act to isolate conductive cover layer 218 from the top electrode (conductive layer 206). Sealant material 220 may also function, in some embodiments, as an adherent or a glue material that keeps all components together. For shielding purposes, it is important that conductive cover layer 218 has an electric contact with the electric ground (conductive substrate 204 or shield layer or wire 212 of coaxial cable 210).

In some embodiments, the shield layer or wire 212 of coaxial cable 210 may be preferably connected to conductive substrate 204 and/or to the top of conductive cover layer 218 with a conductive adhesive, by soldering/welding or via any other known method in the art. Moreover, in some embodiments, core wire 214 of coaxial cable 210 may be attached to the top electrode (conductive layer 206) using a substantially conductive adhesive material.

In some embodiments, some or all the components of single-element ultrasonic transducer 200 discussed above may also be made, at least in part, of substantially flexible materials so as to provide transducer 200 with some flexibility so as to easily adapt to curved parts or surfaces of structure 102.

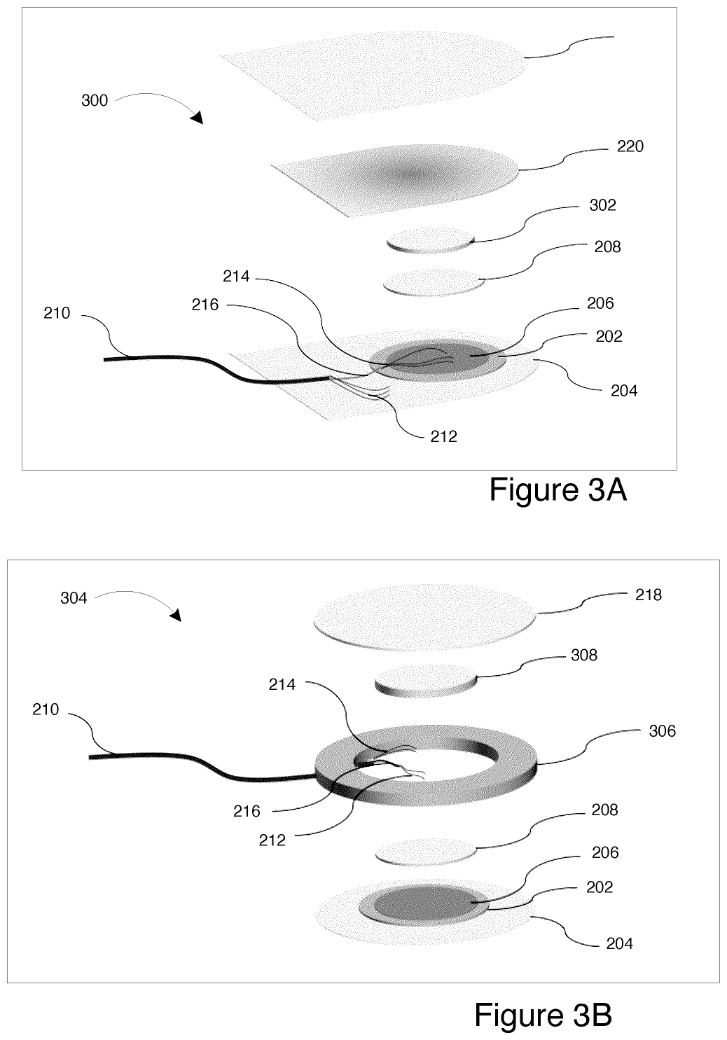

Other embodiments, illustrated in the exploded views of FIGS. 3A and 3B, may optionally add a magnet 302, 306 to provide means to removably attach a single-element ultrasonic transducer to the part or structure 102 to be monitored when this part or structure 102 is composed, at least in part, of a ferromagnetic material. This may be useful during installation for keeping single-element ultrasonic transducer 200 in place during the curing of adhesive used to permanently attach the transducer to part or structure 102 or may also be used with a non-permanent coupling making single-element ultrasonic transducer 200 re-usable.

Thus, the exemplary embodiment shown in FIG. 3A shows another embodiment of a single-element ultrasonic transducer 300, substantially similar to the embodiment 200 of FIGS. 2A and 2B, but further comprising a magnet 302 located above piezoelectric film 202 and both electrodes (conductive substrate 204 and conductive layer 206) so as to provide a direct compression force in the active area of single-element transducer 300. In this particular embodiment, magnet 302 is located directly above acoustic insulation layer 208 and directly below sealant material 220.

Similarly, in the illustrated embodiment 304 of FIG. 3B, each part or element has a substantially more disk-shaped symmetry, and an annular or ring-shaped magnet 306 is used so as to be installed around piezoelectric film 202, which results in magnet 306 being physically closer to structure 102 which is to be monitored, thus advantageously providing a stronger holding force. This exemplary embodiment may further comprise a substantially disk-shaped rubber-like element 308 installed or located inside magnet 306 and configured so as to generate a downward compression force. This embodiment may also comprise sealant 220 shown in previous embodiments, which was omitted in FIG. 3B for better clarity only.

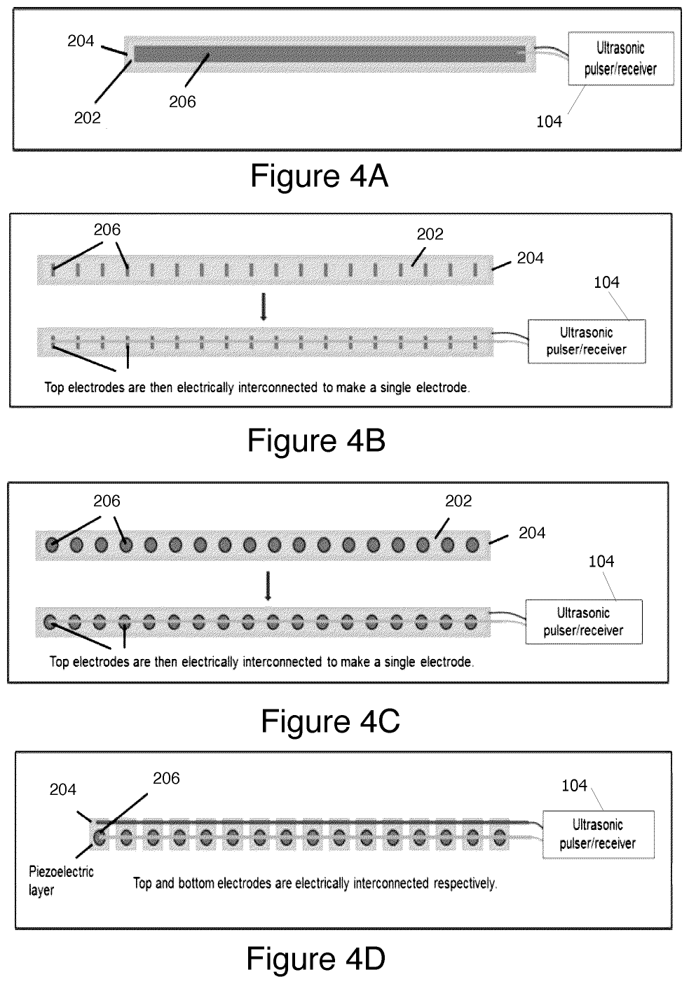

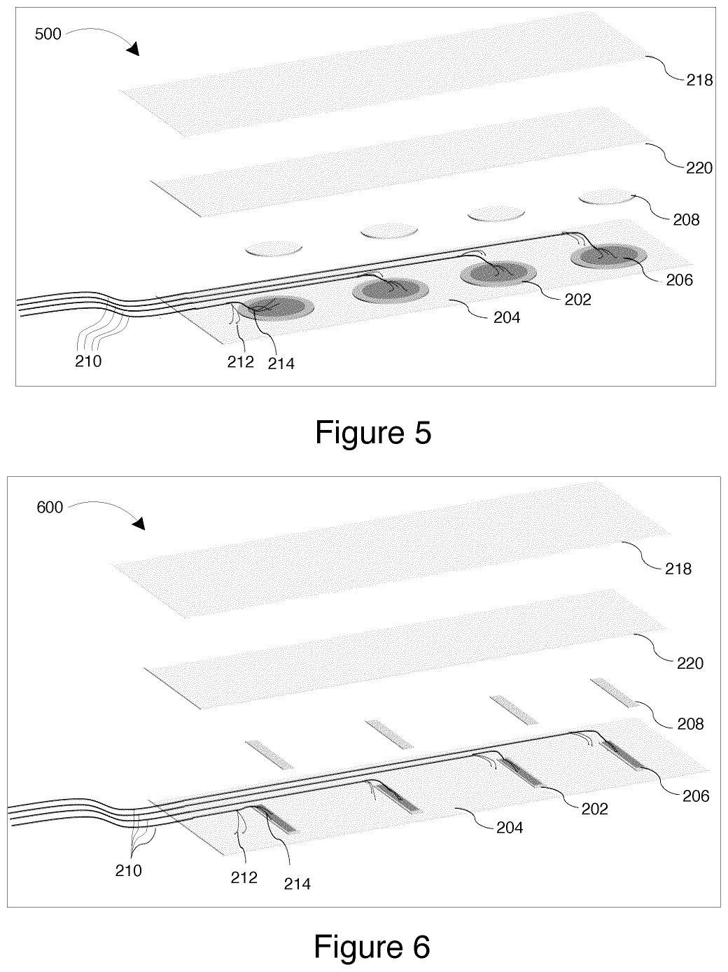

With reference to FIGS. 4 to 6, and in accordance with different embodiments, an ultrasonic transducer comprising multiple sensing elements will be discussed, referred to generally as multi-element transducers. As will be further discussed below, the multi-element transducers discussed herein generally comprise two or more sensing elements, each comprising its own piezoelectric film 202 but connected together to provide a single transducer device or assembly. Moreover, these two or more sensing elements in a multi-element transducer may be connected together in different ways, as will be discussed below. Finally, while the exemplary embodiments of FIGS. 5 and 6 illustrate multi-element transducers comprising 4 distinct sensing elements, this is done as an example only, and any number of sensing elements may be connected or joined as described below, without limitation. Furthermore, as provided above, although application to structural health or wear monitoring is illustrated here, the disclosure applies to other ultrasonic applications such as monitoring of corrosion, crackserosion, fatigue, creep, pitting, or icing. Various applications in monitoring structural wear or changes that can compromise function and/or cause failure of the part or surface will be known to those skilled in the art.

In some embodiments, a structural health monitoring device may be extended spatially, in a linear fashion or other, so as to cover larger areas of a structure or object. Some examples are schematically illustrated in FIGS. 4A to 4D. For example, FIG. 4A shows a structural health monitoring device comprising a single-element transducer having different elements (conductive substrate 204 (bottom electrode), piezoelectric film 202, and conductive layer 206 (top electrode)) having substantial spatial extent in one direction, thereby having the shape of a rectangular band or strip. FIG. 4B shows another example where a single strip or band of bottom electrode layer 204 and a piezoelectric film 202 are used, as before, but where a multiplicity of localized top electrodes (conductive layer 206) are deposited along their length. In this embodiment, multiplicity of localized top electrodes (conductive layer 206) are bar-shaped, as shown. These top electrodes (conductive layers 206) may be electrically interconnected. FIG. 4C shows an embodiment similar to the one of FIG. 4B, but where the multiplicity of top electrodes (conductive layers 206) are disk-shaped. FIG. 4D shows an embodiment where individual single-element ultrasonic transducers, similar to those of FIGS. 2A to 3B, are individually connected. The skilled technician will understand that different embodiments may have different spatial resolutions, depending on the relative position or size of each piezoelectric film 202, and the region or portion of a structure or object being covered by it.

Similarly, FIGS. 5 to 7 show additional exemplary embodiments of a structural health monitoring device comprising a multi-element ultrasonic transducer. For example, FIG. 5 shows an exemplary embodiment of a multi-element ultrasonic transducer, generally referred to using the numeral 500, where each individual sensing element comprises its own piezoelectric film 202, top electrode 206 and acoustic insulation layer 208, configured as discussed above in the context of a single-element transducer, but sharing a same continuous band or strip of conductive substrate 204 (at the bottom to act as the bottom electrode as before) and sharing a same cover conductive layer 218 (at the top). A single band or layer of sealant material 220 may be applied to fill any space in-between the two shared layers 204, 218, as discussed above. As shown, each individual sensing element is generally disk shaped. In this embodiment, each sensing element is shown being individually connected to its own corresponding coaxial cable 210. Such an exemplary embodiment allows for the independent ultrasonic structural health monitoring in various places by allowing the acquisition of distinct echo signals for each sensing element.

Notably, the number of sensing elements, their shape and/or the geometry of their relative location may be greatly varied to include configurations other than the linear array configuration shown in FIG. 5. For example, the shape of each sensing element may include square, rectangle, disk or ring configurations and any other shape. Moreover, the geometry or configuration of each element and the distance between them may also be tailored for each specific application or to the structure or object to be monitored, as required. FIG. 6 shows an exemplary embodiment of a multi-element ultrasonic transducer, generally referred to using reference numeral 600, similar to the embodiment of FIG. 5, but comprising rectangular shaped sensing elements.

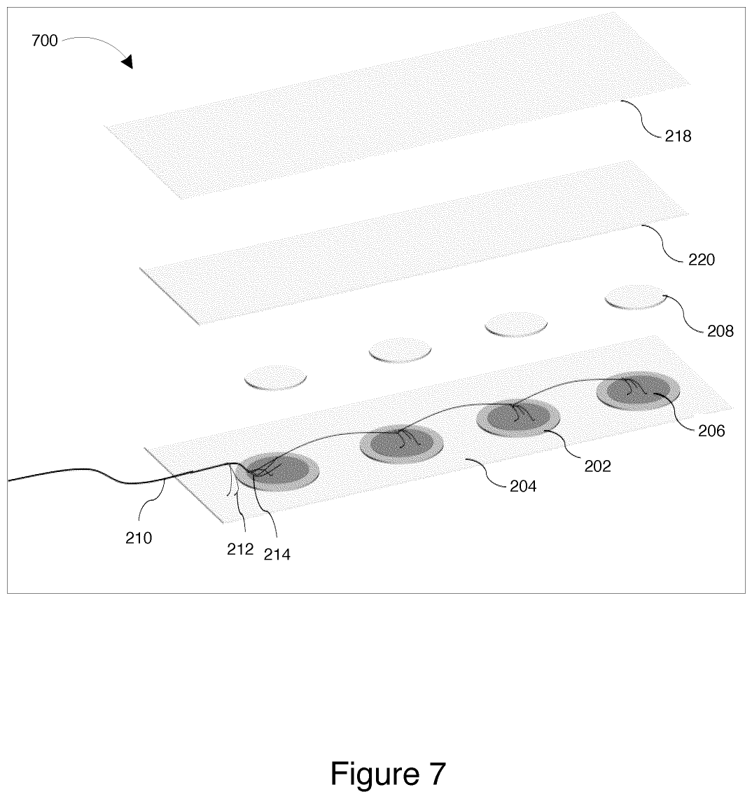

In some embodiments, each sensing element in a multi-element transducer may be connected to the same coaxial cable. An example is illustrated FIG. 7, which shows an embodiment similar to the example shown in FIG. 5, but in which each sensing element is connected in series via single coaxial cable 210. Thus, in this specific example, a single channel may be used to cover a large area at the expense of more localized information. This embodiment may generally be operable to identify, for example, a smallest thickness portion or region (e.g. hₘᵢₙ) of structure 102.

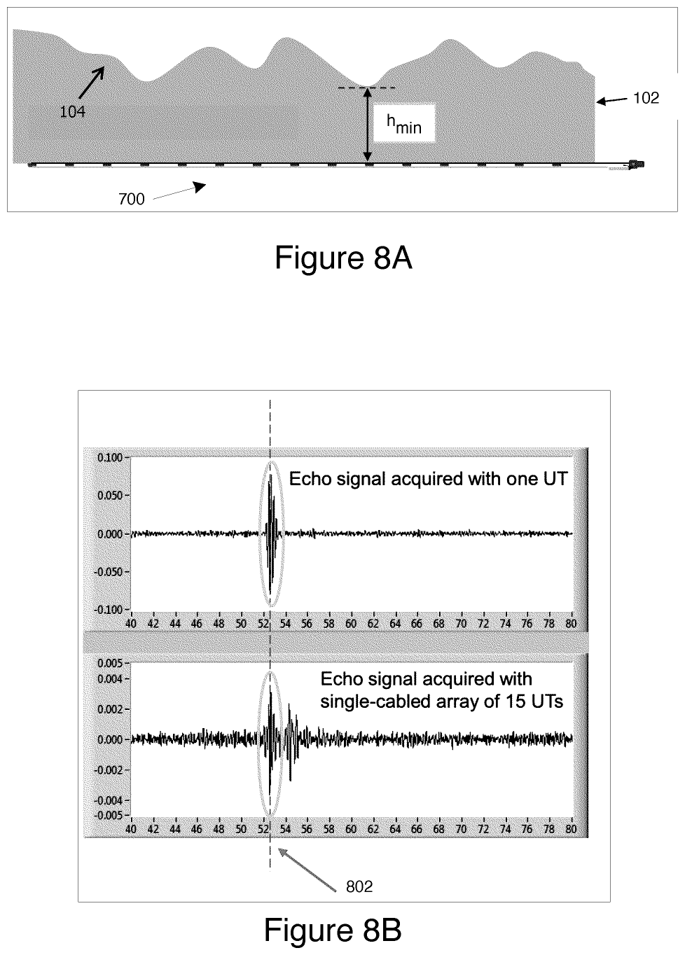

Indeed, in the example above using a single coaxial cable (FIG. 7), all the input electrical signals and the returning echo signals have to travel through the same cable or channel. Thus, as illustrated in FIGS. 8A and 8B, such a design may be used to rapidly determine a smallest thickness parameter (e.g. hₘᵢₙ in FIG. 8A) from the structure or object 102 being monitored. An example is shown schematically in FIG. 8A, wherein a multi-element ultrasonic transducer 700 is shown being attached to a liner (structure or object 102) having different levels of wear on the opposite surface 104 along the direction of the multi-element ultrasonic transducer 700. In this case, since every sensing element receives the same input signal, they will all transmit a return echo signal at different times due to the changing height of surface 104. Thus, the first echo signal to be received will be from the sensing element located at a location where structure or object 102 represents the smallest thickness (hₘᵢₙ). While no spatial information may be extracted, it may provide a general indication of the highest level of wear or degradation of structure or object 104.

FIG. 8B shows such a measured echo signal acquired using a single-element (on top) and multi-element (at the bottom) ultrasonic transducer comprising 15 sensing elements attached to a 16-cm thick white iron liner 102. In both signals, a distinctive echo signature 802 is apparent, indicative of the thinnest region or portion of the liner 102 unto which these transducers where attached.

Many other configurations based on the same principles discussed above may be readily envisaged, without limitation. For example, in some embodiments, it may be advantageous to connect one or more sensing elements to an ultrasonic excitation and/or use one or more sensing elements for detection.

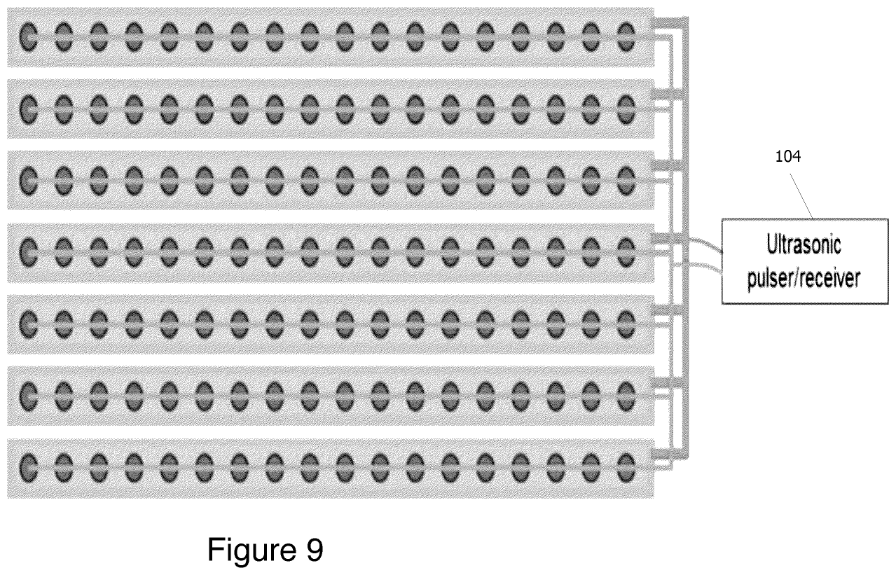

Moreover, while the examples of FIGS. 4A to 7 are directed towards multi-element transducers extending linearly in one direction only, in some embodiments, two or more of such linear multi-element transducers may be deployed side-by-side, as illustrated schematically in FIG. 9, so as to cover a substantial two-dimensional (2D) portion or region. The skilled technician will understand that the connection topology illustrated in FIG. 9 is an example only, and that different electrical connection configurations may be used to interconnect one or more multi-element ultrasonic transducers in a two-dimensional arrangement.

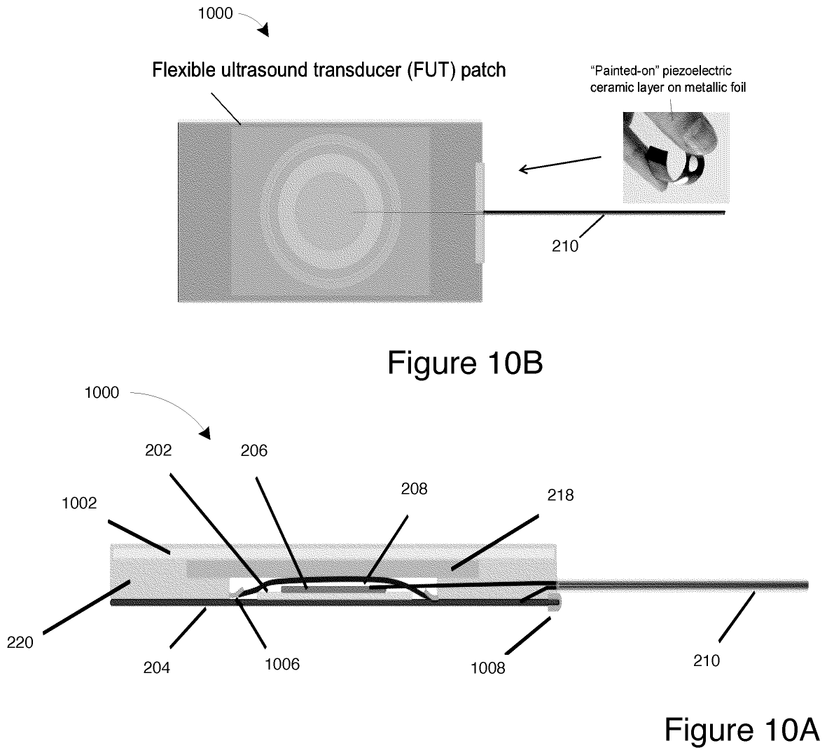

With reference to FIGS. 10A to 16B, and in accordance with different embodiments, other examples of structural health monitoring devices to be embedded between a liner and an intermediate layer or between a liner and a structural support layer are discussed. These exemplary embodiments may be used, for example, with lined structures. These are widely used in industries involving handling and/or treatment of abrasive and/or corrosive materials. Thus, a lined structure may be composed of a mechanically strong outside layer to provide structural support, and an inside lining to protect the outside structural support against abrasion and/or corrosion by materials flowing through or contained inside the lined structure. In the mining, as well as oil and gas industries, inspection of lining wear is usually conducted during planned shutdown of production to allow direct access to the lining. It is sometimes desirable that wear rate be monitored without interrupting a production, as this would allow equipment maintenance to be scheduled in a manner not only to maximise the useful lifetime of the lining while ensuring its reliability, but also to allow replacement liners to be ordered in time to assure timely liner change-outs. Traditional ultrasound non-destructive inspection (NDT) techniques have been very successful in inspection of single-wall structures, for example, certain types of carbon steel pipes and high-pressure vessels, from outside the structure, without interrupting the production or service. However, these NDT techniques may not be suitable for lining wear inspection of a lined structure as either diagnostic ultrasonic waves may not be able to propagate through multiple walls to the worn lining surface and come back to the receiver, or the echo signal reflected from the worn surface may be so weak that it is completely masked by much stronger echo signals reflected from interfaces between layers. This approach is particularly problematic in cases where an intermediate layer lies between the outside structural support layer and the lining.

In some embodiments, the structural health monitoring device described below may be integrated into a lined structure during its fabrication. Target lined structures include, but are not limited to, three-layer lined structures, for example lined pipes, conveyor transfer point liners, and many types of two-layer structures lined with rubber or polyethene, or any lined structure in which each layer conformally bonds to all neighbouring layers.

In some embodiments, an ultrasonic transducer may be hardwired to a coaxial cable for direct excitation and detection of diagnostic acoustic waves, as discussed above, or be wired to an induction coil for inductive excitation and detection of diagnostic acoustic waves.

In some embodiments, an ultrasonic transducer may have a single sensing element serving both as a transmitter and a receiver and in which case only one coaxial cable or only one induction coil is wired to the ultrasonic transducer.

In some embodiments, a transducer may also have dual elements, of which one serves as a transmitter and the other one as a receiver and each of which is connected to a separate coaxial cable or a separate induction coil.

In some embodiments, a single-element transducer may also be used passively to detect acoustic waves generated by objects impinging on or rubbing the liner and convert the acoustic waves to electric signals to be picked up by an electronic acquisition and information processing system for determination of liner wear.

With reference to FIGS. 10A and 10B, and in accordance another exemplary embodiment, a structural health monitoring device comprising a single-element transducer to be embedded into a structure for liner wear detection, generally referred to using the numeral 1000, will now be discussed.

FIGS. 10A and 10B illustrate schematically a side view and a top view, respectively, of an exemplary single-element transducer 1000. In this example, transducer 1000 is once again made of a bottom electrode portion (conductive substrate 204), which may be composed of a metallic foil or similar, over which there is deposited a piezoelectric film or layer 202, which has a top electrode portion (conductive layer 206) also deposited thereon, and over which is found an acoustic insulation layer 208.

In some embodiments, piezoelectric film or layer 202 may be made from a mix of a piezoelectric ceramic powder with a binding material, sprayed onto conductive substrate 204 (forming bottom electrode portion).

In some embodiments, acoustic insulation layer 208 may also be electrically insulating. Different examples of materials used for insulation layer 208 may include paper, mica, Teflon or other materials suitable for acoustic and/or electrical insulation.

In contrast to the embodiments described above, the exemplary embodiment of FIGS. 10A and 10B comprises both a conductive waterproof cover layer 218, which may be made of a ductile metallic foil for example, but also a plastic protective film 1002 layered thereon. Protective plastic film 1002 and conductive waterproof cover layer 218 may be bonded to the single-element transducer 1000, as illustrated in FIG. 10A, with one or more adhesive (sealant) layers 220, made for example from an ultralow water vapor transfer rate (WVTFR) adhesive.

In some embodiments, conductive substrate 204 (cover) may be made of, for example, aluminum foil to provide sufficient humidity protection for piezoelectric layer 202 while plastic protective film 1002 is used for protection from mechanical mishandling.

In some embodiments, plastic protective film 1002 may be pre-coated with a hot-melt adhesive. In addition, in some embodiments, a pouch laminator may be used to apply hot-melted coated plastic protective film 1002. In this case, it may also be desirable to pass single-element transducer 1000 through a pouch laminator shortly after the ultralow WVTR adhesive has been applied. This allows the ultralow WVTR adhesive time to spread uniformly before it is set under the effects of heat and pressure provided by the pouch laminator.

In addition, single-element transducer 1000 may further comprise a protective rim 1006, which may be made from a cutout of a single-side adhesive tape, for example a single-side adhesive polyimide tape. The tape 1006 may be applied to the edge of acoustic insulation layer 208 in such a way that the part of the adhesive side adheres to the upper surface of acoustic insulation layer 208 and part of it adheres to conductive substrate 204. Protective rim 1006 may prevent adhesive layer 220 from entering into contact with piezoelectric layer 202.

Furthermore, in some embodiments and as illustrated in FIG. 10A, single-element transducer 1000 may further comprise an edge cushion 1008. Edge cushion 1008 may be a strip of a single-side adhesive tape, for example a strip of single-side hot-melt laminating film, that is applied to an edge of conductive substrate 204, which may prevent signal wires from being cut by the substrate edge.

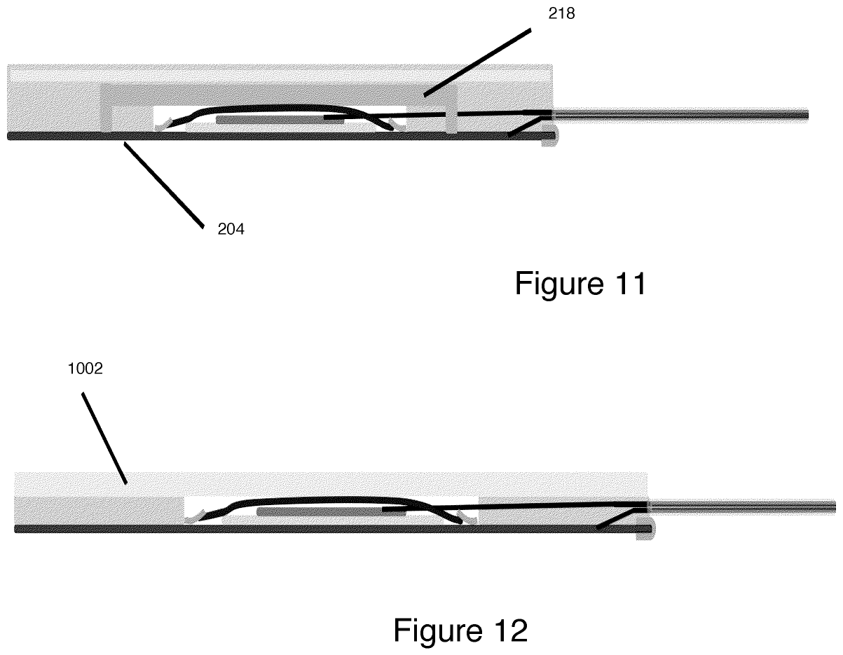

FIG. 11 is a side-view of another embodiment, where conductive cover layer 218 is connected to conductive substrate 204 (bottom electrode) to provide good transducer protection from both electromagnetic interference and humidity.

Similarly, FIG. 12 shows a side-view of yet another embodiment of single-element transducer 1000, for applications where humidity and electromagnetic interference are less of a concern to transducer performance. Thus, the embodiment of FIG. 12 does not have conductive cover layer 218 but only plastic protective film 1002.

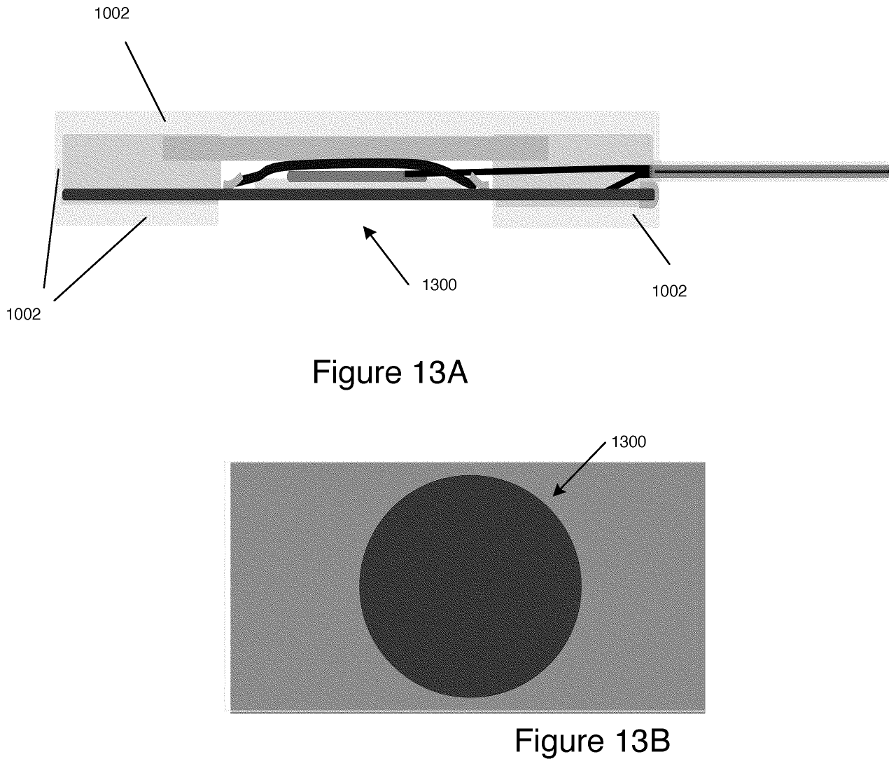

In some embodiments, for enhanced transducer protection against mechanical mishandling and as illustrated in FIGS. 13A and 13B (side-view and bottom-view respectively), the back face of conductive substrate 204 (bottom electrode) can be partially protected with plastic protective film 1002 while leaving open the area 1300 opposing the active sensing element in order not to interfere with acoustic wave transmission and reception by the single-element transducer 1000.

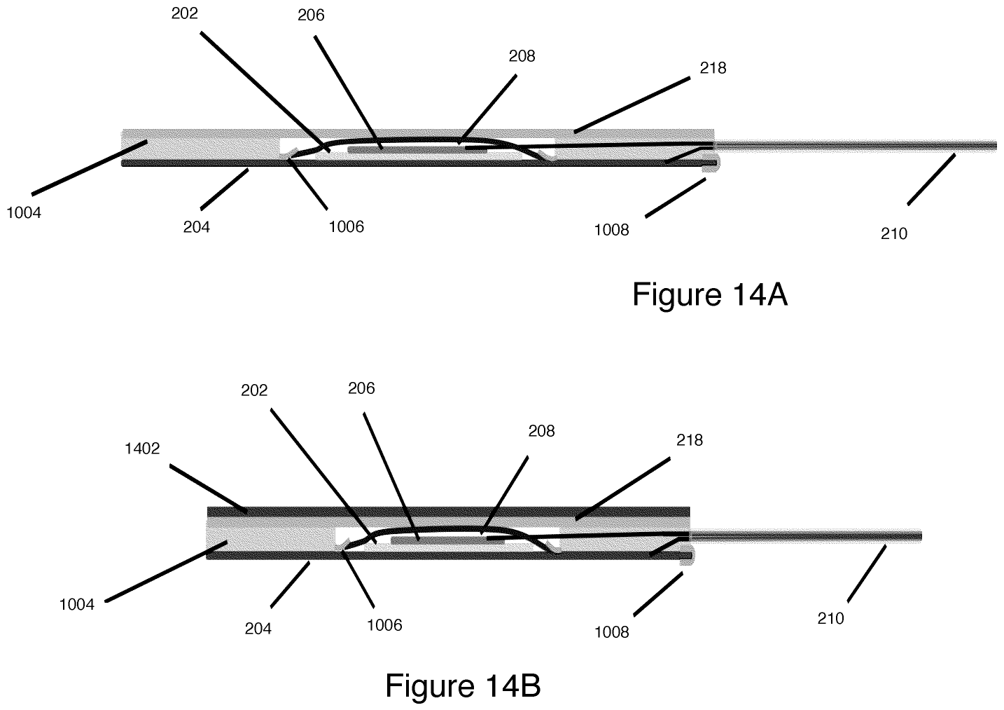

In some embodiments, for applications where ultrasonic transducers are to be embedded between a rubber layer and steel structure, the rubber usually has to be vulcanized at an elevated temperature (for example between 150° C. and 180° C.) after the transducers have been embedded. Therefore, the transducers need to endure vulcanization temperatures. The exemplary sensor structure presented schematically in FIG. 14A is designed to endure high temperatures while providing adequate protection from humidity by using a high-temperature resistant adhesive for adhesive layer 1004. In addition, in this exemplary embodiment, protective rim 1006 and edge cushion 1008 may be made from a high-temperature resistant plastic, for example, polyimide.

Similarly, in some embodiments, to prevent corrosion at the interface between two dissimilar metals in a humid environment, metallic cover layer 218 may be additionally protected with an electrically non-conductive high-temperature resistant coating 1402, as shown in FIG. 14B. The electrically non-conductive high-temperature resistant coating 1402 may be replaced, in some embodiments, with a high-temperature adhesive tape, for example a polyimide adhesive tape.

In some embodiments, the single-element transducers of FIGS. 14A and 14B may be passed through a pouch laminator to allow adhesive to spread uniformly before it is set under the effects of heat and pressure provided by the pouch laminator.

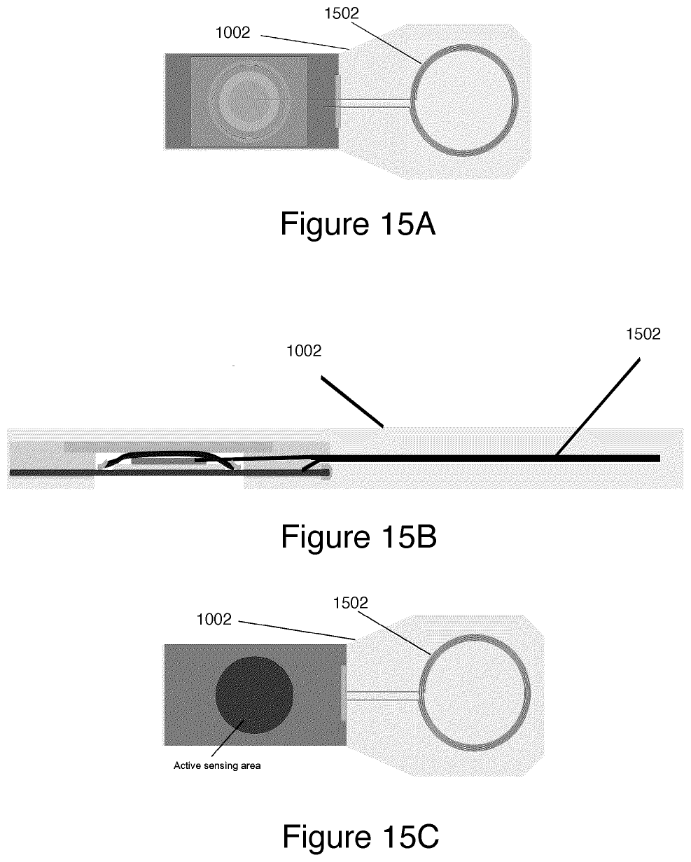

In some embodiments, coaxial cable 210, shown for example in FIG. 10A, may be replaced with an induction coil 1502 for inductive excitation of single-element transducer and inductive signal detection while using a transducer protection method or design illustrated in FIGS. 10A to 14B. This embodiment, particularly utilising induction coil 1502, is schematically illustrated in FIGS. 15A to 15C, which show a top-view, side-view and bottom-view, respectively.

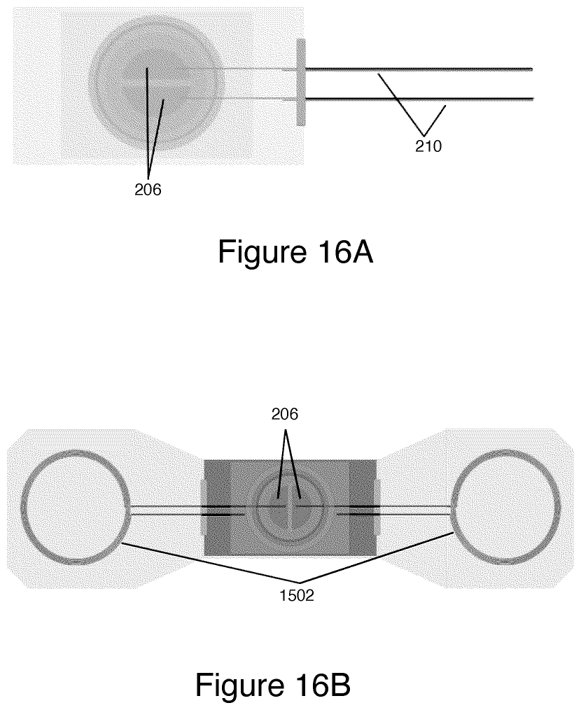

In some embodiments, the transducer protection methods or designs presented above may also apply to a dual-element transducer as well, such as the one illustrated schematically in FIGS. 16A and 16B. In this illustrated example, a dual-element transducer comprises two top electrode layers (conductive layers 206) on a same piezoelectric ceramic layer 202 with each electrode wired to a different cable 210 (FIG. 16A) or induction coil 1502 (FIG. 16B). While a single-element transducer may use the same sensing element as both a transmitter and a receiver, a dual-element transducer may use one sensing element as a transmitter only and the other one as a receiver only. Notably, in the exemplary embodiment of FIG. 16B, the two induction coils 1502 may be of different dimensions, have different numbers of turns, or more generally be arranged or configured differently. For example, they may be arranged concentrically with a smaller coil inside a larger one.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present to claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1. An ultrasonic structural health monitoring device for monitoring a structure, the device comprising:
a bottom electrode disposable on the structure;
a piezoelectric medium disposed on said bottom electrode;
a top electrode disposed on said piezoelectric medium;
an acoustic insulation layer; and
a connector to bring electrical excitation for said piezoelectric medium and to collect a generated electric response therefrom representative of structural health.

2. The device of claim 1, wherein said piezoelectric medium transforms said electrical excitation into a corresponding ultrasonic wave that is reflected as an echo by the structure to produce said generated electric response representative of said structural health.

3. The device of claim 1, wherein a thickness of the structure is represented by an elapsed time between said electrical excitation and said generated electric response, such that a variation in said elapsed time is representative of said structural health.

4. The device of claim 1, wherein said piezoelectric medium comprises a piezoelectric layer deposited on said bottom electrode.

5. (canceled)

6. The device of claim 1, wherein the device further comprises a cover layer.

7-8. (canceled)

9. The device of claim 1, wherein said piezoelectric medium is made from a mix of a piezoelectric ceramic powder with a binding material and sprayed on said bottom electrode.

10-14. (canceled)

15. The device of claim 1, wherein said connector comprises an induction coil.

16. The device of claim 1, further comprising a sealant that fills at least part of the device.

17-20. (canceled)

21. The device of claim 1, further comprising a magnet to removably attach the device to the structure to be monitored.

22-24. (canceled)

25. The device of claim 1, wherein the device further comprises a plastic film layer.

26. (canceled)

27. The device of claim 1, wherein the device further comprises an edge cushion substantially covering at least one edge of said bottom electrode so as to protect said connector.

28. (canceled)

29. The device of claim 1, wherein the device comprises two or more sensing elements, and wherein said connector is connected to each of said two or more sensing elements in series so to commonly bring said electrical excitation to each of said two or more sensing elements.

30-31. (canceled)

32. The device of claim 1, wherein the device comprises two or more sensing elements sharing at least one of said bottom electrode, said piezoelectric medium, said top electrode, or said acoustic insulation layer.

33. (canceled)

34. The device of claim 1, wherein the structure comprises a liner, and wherein the device is embeddable between the structure and the liner so as to monitor liner thickness variation.

35. The device of claim 1, wherein said connector is operatively connected to a pulser/receiver operable to generate said electrical excitation and receive said generated electric response.

36. The device of claim 1, wherein said acoustic insulation layer is disposed over said top electrode.

37. The device of claim 1, wherein said generated electric response representative of structural health is representative of at least one of structural wear, corrosion, pitting, icing or cracking.

38. (canceled)

39. An ultrasonic structural health monitoring system for monitoring a structure, the system comprising:
an ultrasonic structural health monitoring device as claimed in claim 1;
a pulser/receiver operable to generate said electrical excitation and receive said generated electric response; and
a digital processor operable to output indication of said structural health as a function of an elapsed time between said electrical excitation and said generated electrical response.

40. The ultrasonic structural health monitoring system of claim 39:
wherein said ultrasonic structural health monitoring device comprises multiple sensing elements connected in series via a common said connector to be concurrently excited via a same electrical excitation; and
wherein said digital processor is operable to output indication of a maximum wear as a function of a shortest elapsed time between said same electrical excitation and a first said generated electrical response.

41. An ultrasonic structural health monitoring method for monitoring a structure, the method comprising:
affixing to the structure an ultrasonic structural health monitoring device as claimed in claim 1;
exciting said ultrasonic structural health monitoring device via said electrical excitation and collecting said generated electrical response therefrom; and
using a digital processor, monitoring an elapsed time between said electrical excitation and said generated electrical response to output an indication of said structural health as a function of said elapsed time.

42. The method of claim 41:
wherein said ultrasonic structural health monitoring device comprises multiple sensing elements connected in series via a common said connector to be concurrently excited via a same said electrical excitation; and
wherein said digital processor is operable to monitor for a shortest said elapsed time to output indication of a maximum wear as a function of said shortest said elapsed time.
